(19) United States
(12) Patent Application Publication
(10) Pub. No.: US 2025/0016798 A1
(43) Pub. Date: Jan. 9, 2025

(54) METHOD AND DEVICE FOR TRANSMITTING/RECEIVING SIDELINK INFORMATION IN UNLICENSED BAND

(71) Applicant: Samsung Electronics Co., Ltd., Suwon-si, Gyeonggi-do (KR)

(72) Inventors: Sungjin PARK, Suwon-si (KR); Hyunseok RYU, Suwon-si (KR); Cheolkyu SHIN, Suwon-si (KR); Jeongho YEO, Suwon-si (KR)

(21) Appl. No.: 18/701,418

(22) PCT Filed: Oct. 28, 2022
(86) PCT No.: PCT/KR2022/016717

§ 371 Date: Apr. 15, 2024

(30) Foreign Application Priority Data
Oct. 28, 2021 (KR) 10-2021-0145790

(51) Int. Cl. H04W 72/25; H04W 72/0453

(52) U.S. Cl. CPC H04W 72/25; H04W 72/0453

(57) ABSTRACT

The present disclosure relates to a communication technique for converging IoT technology with 5G communication systems for supporting a higher data transfer rate beyond 4G systems, and a system therefor. The present disclosure may be applied to intelligent services (for example, smart homes, smart buildings, smart cities, smart cars or connected cars, healthcare, digital education, retail businesses, security-and safety-related services, etc.) on the basis of 5G communication technology and IoT-related technology. In addition, the present disclosure relates to a method and a device for transmitting/receiving sidelink information in an unlicensed band.

### TECHNICAL FIELD

The disclosure relates to a method for transmitting and receiving sidelink information in a wireless communication system and, more specifically, to a method and a device for configuring sidelink information in an unlicensed band and transmitting and receiving the same.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a “beyond 4G network” communication system or a “post LTE” system. The 5G communication system defined by 3GPP is called a “New Radio (NR) system”.

The 5G communication system is considered to be implemented in ultrahigh frequency (mmWave) bands (e.g., 60 GHz bands) so as to accomplish higher data rates. To decrease path loss of radio waves and increase the transmission distance of the radio waves in the ultrahigh frequency bands, beamforming, massive multiple-input multiple-output (massive MIMO), full dimensional MIMO (FD-MIMO), array antenna, analog beam forming, and large scale antenna techniques have been discussed in the 5G communication system and applied to the NR system.

In addition, in the 5G communication system, development for system network improvement is under way based on advanced small cells, cloud radio access networks (cloud RANs), ultra-dense networks, device-to-device (D2D) communication, wireless backhaul, moving network, cooperative communication, coordinated multi-points (COMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology (IT) services that create a new value to human life by collecting and analyzing data generated among connected things. IT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology.

With the advance of wireless communication systems as described above, various services can be provided, and accordingly there is a need for schemes to effectively provide these services.

### DISCLOSURE OF INVENTION

### Technical Problem

The disclosure relates to a method for configuring sidelink broadcast information in a sidelink communication system, and a method and a device for transmitting and receiving the same.

### Solution to Problem

In order to solve the above-described problem, a method by a first terminal in a communication system according to an embodiment of the disclosure may include transmitting a physical sidelink control channel (PSCCH) for allocating resources of a physical sidelink shared channel (PSSCH), and transmitting, based on the PSCCH, the PSSCH in a first sub-channel, wherein the first sub-channel is defined based on a plurality of interlace blocks allocated at regular intervals in a frequency domain.

A method by a second terminal in a communication system according to an embodiment of the disclosure may include receiving a physical sidelink control channel (PSCCH) allocating resources of a physical sidelink shared channel (PSSCH), and receiving, based on the PSCCH, the PSSCH in a first sub-channel, wherein the first sub-channel is defined based on a plurality of interlace blocks allocated at regular intervals in a frequency domain.

A first terminal in a communication system according to an embodiment of the disclosure may include a transceiver, and a controller configured to transmit a physical sidelink control channel (PSCCH) for allocating resources of a physical sidelink shared channel (PSSCH), and to transmit, based on the PSCCH, the PSSCH in a first sub-channel, wherein the first sub-channel is defined based on a plurality of interlace blocks allocated at regular intervals in a frequency domain.

A second terminal in a communication system according to an embodiment of the disclosure may include a transceiver, and a controller configured to receive a physical sidelink control channel (PSCCH) for allocating resources of a physical sidelink shared channel (PSSCH), and to receive, based on the PSCCH, the PSSCH in a first sub-channel, wherein the first sub-channel is defined based on a plurality of interlace blocks allocated at regular intervals in the frequency domain.

### Advantageous Effects of Invention

According to the proposed embodiment, it is possible to improve efficiency in a method for configuring sidelink broadcast information in a sidelink communication system and a process of transmitting and receiving the same.

### BRIEF DESCRIPTION OF DRAWINGS

FIG. 1 illustrates a system for explaining an embodiment of the disclosure;

FIG. 2 illustrates a vehicle to everything (V2X) communication method performed through a sidelink to which an embodiment of the disclosure is applied;

FIG. 3 illustrates a protocol of a sidelink terminal to which an embodiment of the disclosure is applied;

FIG. 4 illustrates types of synchronization signals that can be received by a sidelink terminal to which an embodiment of the disclosure is applied;

FIG. 5 illustrates a frame structure of a sidelink system according to an embodiment of the disclosure;

FIG. 6 illustrates a structure of a sidelink synchronization channel according to an embodiment of the disclosure;

FIG. 7 illustrates a structure of a sidelink channel according to an embodiment of the disclosure;

FIG. 8 illustrates a sub-channel structure for sidelink communication according to an embodiment of the disclosure;

FIG. 9 illustrates a feedback channel structure for sidelink communication according to an embodiment of the disclosure;

FIG. 10 illustrates an example of a structure in which synchronization signals are transmitted and received according to an embodiment of the disclosure;

FIG. 11 illustrates another example of a structure in which synchronization signals are transmitted and received according to an embodiment of the disclosure;

FIG. 12 illustrates still another example of a structure in which synchronization signals are transmitted and received according to an embodiment of the disclosure;

FIG. 13 illustrates yet another example of a structure in which synchronization signals are transmitted and received according to an embodiment of the disclosure;

FIG. 14 illustrates an operation process for sidelink communication of a terminal in an unlicensed band according to an embodiment of the disclosure;

FIG. 15 illustrates a structure of a terminal according to an embodiment of the disclosure; and

FIG. 16 illustrates the structure of a base station according to an embodiment of the disclosure.

### MODE FOR THE INVENTION

Hereinafter, exemplary embodiments of the disclosure will be described in detail with reference to the accompanying drawings. It should be noted that, in the drawings, the same or like elements are designated by the same or like reference signs as much as possible. Furthermore, a detailed description of known functions or configurations that may make the subject matter of the disclosure unclear will be omitted.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

The following detailed description of embodiments of the disclosure is directed to New RAN (NR) as a radio access network and Packet Core as a core network (5G system, 5G Core Network, or new generation core (NG Core)) which are specified in the 5G mobile communication standards defined by the 3rd generation partnership project long term evolution (3GPP LTE) that is a mobile communication standardization group, but based on determinations by those skilled in the art, the main idea of the disclosure may be applied to other communication systems having similar backgrounds or channel types through some modifications without significantly departing from the scope of the disclosure.

In 5G systems, a network data collection and analysis function (NWDAF), which is a network function for analyzing and providing data collected in a 5G network, may be defined to support network automation. The NWDAF may collect/store/analyze information from the 5G network and provide the result to at least one network function (NF), and each NF may independently use the analysis result.

In the following description, some of terms and names defined in the 3rd generation partnership project (3GPP) long term evolution (LTE) standards (standards for 5G, NR, LTE, or similar systems) may be used for the sake of descriptive convenience. However, the disclosure is not limited by these terms and names, and may be applied in the same way to systems that conform other standards.

Furthermore, in the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

To meet the demand for wireless data traffic having increased since deployment of 4G communication systems, efforts have been made to develop an improved 5G (i.e., NR) communication system. The 5G communication system has been designed to be supported in ultrahigh frequency (mmWave) bands (e.g., 28 GHz frequency bands) so as to accomplish higher data rates. To decrease path loss of radio waves and increase the transmission distance of the radio waves in the ultrahigh frequency bands, beamforming, massive multiple-input multiple-output (massive MIMO), full dimensional MIMO (FD-MIMO), array antenna, analog beam forming, and large scale antenna techniques are discussed in the 5G communication system. In addition, unlike LTE, various subcarrier spacings such as 15 KHz, 30 kHz, 60 kHz, and 120 kHz are supported, a physical control channel uses polar coding, and a physical data channel uses low density parity check (LDPC) in the 5G communication system. Furthermore, not only discrete Fourier transform spread orthogonal frequency division multiplexing (DFT-S-OFDM) but also cyclic prefix based OFDM (CP-OFDM) are used as a waveform for uplink transmission. While LTE supports hybrid automatic repeat request (HARQ) retransmission in units of transport blocks (TBs), 5G may additionally support HARQ retransmission based on a code block group (CBG) that is a bundle of multiple code blocks (CBs).

Accordingly, various attempts have been made to apply the 5G communication system to IoT networks. For example, technologies such as a sensor network, machine type communication (MTC), and machine-to-machine (M2M) communication are implemented by the 5G technology such as beamforming, MIMO, and array antenna techniques. Application of a cloud radio access network (cloud RAN) as the above-described big data processing technology may also be considered an example of convergence of the 5G technology with the IoT technology. As such, multiple services may be provided to a user in a communication system, and in order to provide these multiple services to the user, there is a need for a method by which the respective services can be provided suitably to their features in the same time interval, and an apparatus using the method. Various services to be provided in the 5G communication system are being studied, and one of them is a service that satisfies the requirements for low latency and high reliability.

In the case of vehicular communication, LTE-based V2X has been standardized in 3GPP Rel-14 and Rel-15, based on a device-to-device (D2D) communication structure. Efforts are being made to develop 5G new radio (NR)-based V2X. In NR V2X, support for unicast communication, groupcast (or multicast) communication, and broadcast communication will be available between terminals. Unlike the LTE V2X that aims to transmit and receive basic safety information required for road driving of a vehicle, the NR V2X aims to provide more advanced services, such as platooning, advanced driving, extended sensors, and remote driving.

Since the aforementioned advanced services require a high data rate, the NR V2X system may need a relatively wide bandwidth compared to the conventional 4G LTE V2X system. To this end, it is necessary to support operation in a high frequency bandwidth and solve a coverage issue caused by frequency characteristics through analog beamforming. In such an analog beamforming system, a method and a device for acquiring beam information between a transmission UE and a reception UE are required.

Embodiments of the specification are proposed to support the above-described scenario and aim to provide a method of configuring sidelink broadcast information to perform sidelink synchronization between UEs and a method and a device for transmitting and receiving the same.

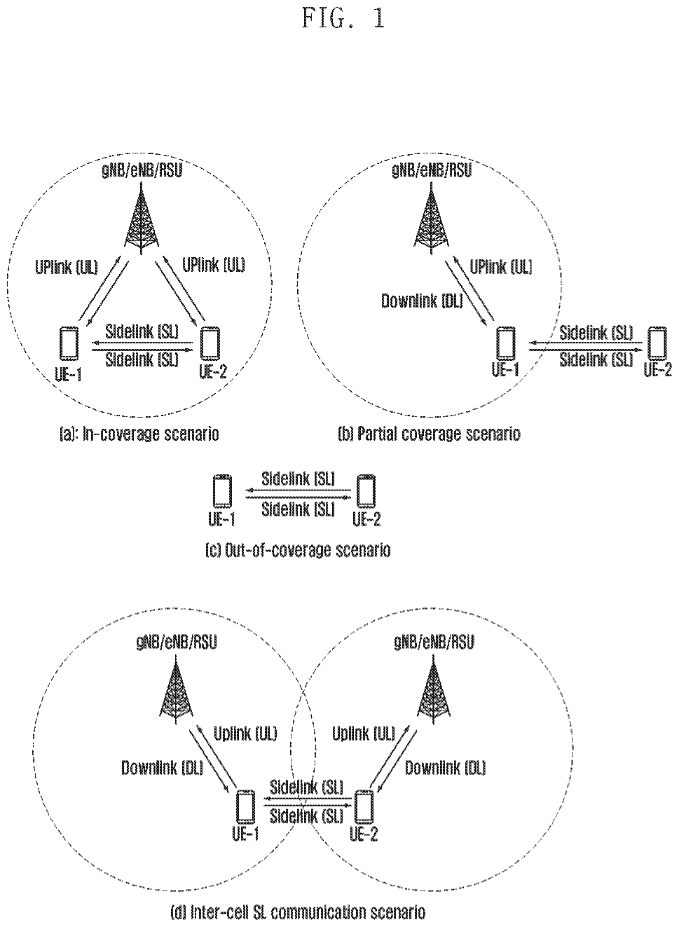

FIG. 1 illustrates a system for explaining an embodiment of the disclosure.

FIG. 1A is an example of a case in which all V2X UEs (UE-1 and UE-2) are located within the coverage of a base station.

All the V2X UEs located within the coverage of the base station are capable of receiving data and control information from the base station through a downlink (DL) and transmitting data and control information to the base station through an uplink (UL). Such data and control information may be data and control information available for V2X communication. Alternatively, such data and control information may be data and control information for general cellular communication. In addition, the V2X UEs may transmit and receive data and control information for V2X communication through a sidelink (SL).

FIG. 1B illustrates an example of a case in which, among V2X UEs, UE-1 is located within the coverage of a base station and UE-2 is located outside the coverage of a base station. The example according to FIG. 1B may be referred to as an example of a partial coverage.

UE-1 located within the coverage of the base station is capable of receiving data and control information from the base station through a downlink and transmitting data and control information to the base station through an uplink.

UE-2 located out of the coverage of the base station is incapable of receiving data and control information from the base station through the downlink and transmitting data and control information to the base station through the uplink.

UE-2 may transmit and receive data and control information for V2X communication to and from UE-1 through a sidelink.

FIG. 1C illustrates an example of a case in which all V2X UEs are located out of the coverage of a base station.

Accordingly, UE-1 and UE-2 are incapable of receiving data and control information from the base station through a downlink and transmitting data and control information to the base station through an uplink.

UE-1 and UE-2 may transmit and receive data and control information for V2X communication through a sidelink.

FIG. 1D illustrates an example of a scenario in which V2X communication is performed between UEs located in different cells. Specifically, in FIG. 1D, a V2X transmission UE and a V2X reception UE are connected to different base stations (i.e., an RRC connected state) or camp on difference cells (i.e., an RRC connection released state or an RRC idle state). Here, UE-1 may be the V2X transmission UE, and UE-2 may be the V2X reception UE. Alternatively, UE-1 may be the V2X reception UE, and UE-2 may be the V2X transmission UE. UE-1 may receive a V2X-dedicated system information block (SIB) from a base station to which UE-1 is connected (or from a base station of a cell on which UE-1 camps), and UE-2 may receive a V2X-dedicated SIB from another base station to which UE-2 is connected (or from a base station of a cell on which UE-2 camps). Information of the V2X-dedicated SIB received by UE-1 and information of the V2X-dedicated SIB received by UE-2 may be identical with or different from each other. In case that both of the SIB information are different from each other, UE-1 and UE-2 may receive different information for sidelink communication, as SIBs, from their connected (or camping-on) base stations, respectively. In this case, there is a need to unify information in order to perform sidelink communication between UEs located in different cells.

Although FIG. 1 illustrates a V2X system including two UEs (UE-1 and UE-2), for convenience of description, the disclosure is not limited thereto. In addition, an uplink and a downlink between a base station and a V2X UE may be referred to as a Uu interface, and a sidelink between V2X UEs may be referred to as a PC5 interface. Therefore, the terms may be used interchangeably in the disclosure.

Meanwhile, in the disclosure, a terminal may refer to a terminal that supports device-to-device (D2D) communication, a vehicle that supports vehicle-to-vehicle (V2V) communication, a vehicle or a pedestrian's handset (i.e., a smartphone) that supports vehicle-to-pedestrian (V2P) communication, a vehicle that supports vehicle-to-network (V2N) communication, or a vehicle that supports vehicle-to-infrastructure (V2I) communication. In addition, in the disclosure, the terminal may refer to a road side unit (RSU) having a UE function, an RSU having a base station function, or an RSU having a part of the base station function and a part of the UE function.

In the disclosure, the V2X communication may refer to D2D communication, V2V communication, or V2P communication, and may be used interchangeably with sidelink communication.

Further, in the disclosure, a base station is pre-defined as a base station that may support both V2X communication and general cellular communication, or a base station that may support only V2X communication. In addition, the base station may refer to a 5G base station (gNB), a 4G base station (eNB), or a road site unit (RSU). Therefore, unless otherwise specified in the disclosure, the above terms related to the base station and the RSU may be used interchangeably.

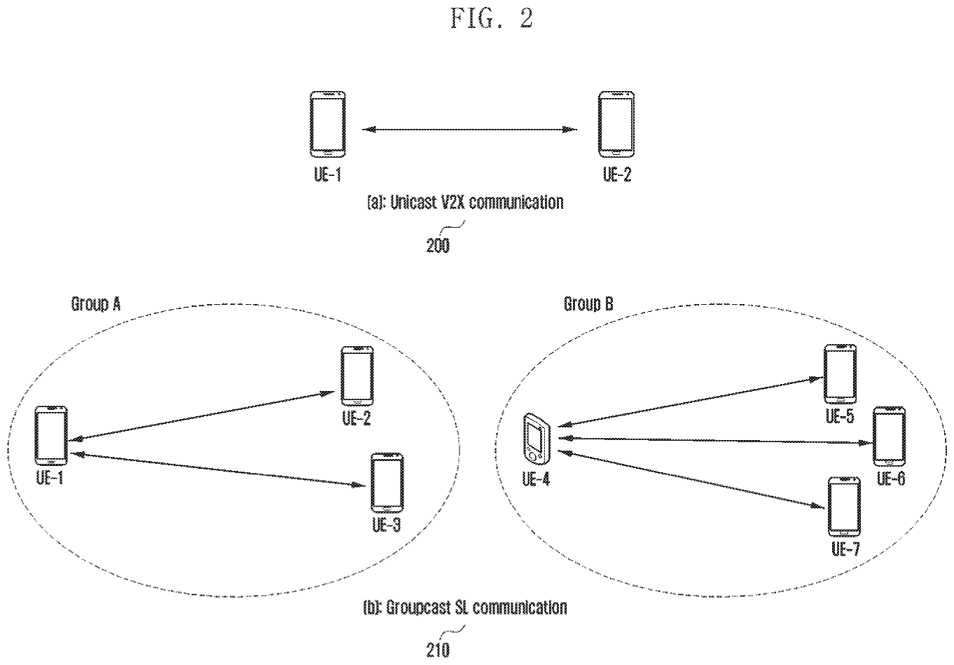

FIG. 2 illustrates a V2X communication method performed through a sidelink to which an embodiment of the disclosure is applied.

As shown in FIG. 2A, a transmission UE (UE-1) and a reception UE (UE-2) may perform one-to-one communication, which may be referred to as unicast communication.

As shown in FIG. 2B, a transmission UE (UE-1 or UE-4) and reception UEs (UE-2 and UE-3, or UE5, UE-6, and UE-7) may perform one-to-many communication, which may be referred to as groupcast or multicast communication.

In FIG. 2B, UE-1, UE-2, and UE-3 form one group (group A) and perform groupcast communication, and UE-4, UE-5, UE-6, and UE-7 form another group (group B) and perform groupcast communication. Each UE performs groupcast communication only within a group to which each UE belongs. Communication between different groups may be performed via one of unicast, groupcast, or broadcast communication methods. Although FIG. 2B illustrates two groups, the disclosure is not limited thereto.

Meanwhile, although not shown in FIG. 2, V2X UEs may perform broadcast communication. The broadcast communication may refer to a case in which all V2X UEs receive data and control information transmitted by a V2X transmission UE through a sidelink. For example, in FIG. 2B, when it is assumed that UE-1 is a transmission UE for broadcast, all the other UEs (i.e., UE-2, UE-3, UE-4, UE-5, UE-6, and UE-7) may be reception UEs that receive data and control information transmitted by the UE-1.

Sidelink unicast, groupcast, and broadcast communication methods according to an embodiment of the disclosure may be supported in in-coverage, partial-coverage, and out-of-coverage scenarios.

In a sidelink system, resource allocation may use the following methods.

### (1) Mode 1 Resource Allocation

This refers to a method of resource allocation scheduled by a base station (scheduled resource allocation). More specifically, in mode 1 resource allocation, the base station may allocate resources used for sidelink transmission to RRC-connected UEs in a dedicated scheduling scheme. The scheduled resource allocation method may be effective for interference management and resource pool management (dynamic allocation and/or semi-persistent scheduling (SPS)) because the base station can manage the resources of a sidelink. When there is data to be transmitted to other UE(s), the RRC connected mode UE may use a radio resource control (RRC) message or a medium access control (MAC) control element (CE) to inform the base station that there is data to be transmitted to other UE(s). For example, the RRC message may be a sidelink UE information (SidelinkUEInformation) message or a UE assistance information (UEAssistanceInformation) message. In addition, the MAC CE may be a buffer status report (BSR) MAC CE, scheduling request (SR), etc. including at least one of an indicator indicating a BSR for V2X communication and information on the size of data buffered for sidelink communication. Since resources are scheduled for the sidelink transmission UE by the base station, the mode 1 resource allocation method can be applied when the V2X transmission UE is within the coverage of the base station.

### (2) Mode 2 Resource Allocation

Mode 2 allows the sidelink transmission UE to autonomously select resources (UE autonomous resource selection). Specifically, in mode 2, the base station provides a sidelink transmitting/receiving resource pool for the sidelink to the UE through system information or an RRC message (e.g., RRCReconfiguration message or a PC5-RRC message), and the transmission UE that has received the transmitting/receiving resource pool selects a resource pool and a resource in accordance with a predetermined rule. In the above example, since the base station provides configuration information on the sidelink transmitting/receiving resource pool, the mode 2 resource allocation method can be applied when the sidelink transmission UE and reception UE are within the coverage of the base station. In case that the sidelink transmission UE and reception UE exist outside the coverage of the base station, the sidelink transmission UE and reception UE may perform the mode 2 operation in a preconfigured transmitting/receiving resource pool. The UE autonomous resource selection method may include zone mapping, sensing-based resource selection, random selection, and the like.

(3) Additionally, resource allocation or resource selection may not be performed in the scheduled resource allocation mode or the UE autonomous resource selection mode even if the UEs exist in the coverage of the base station. In this case, the UE may perform sidelink communication through a preconfigured sidelink transmitting/receiving resource pool (preconfiguration resource pool).

The sidelink resource allocation method according to the above embodiment of the disclosure may be applied to various embodiments of the disclosure.

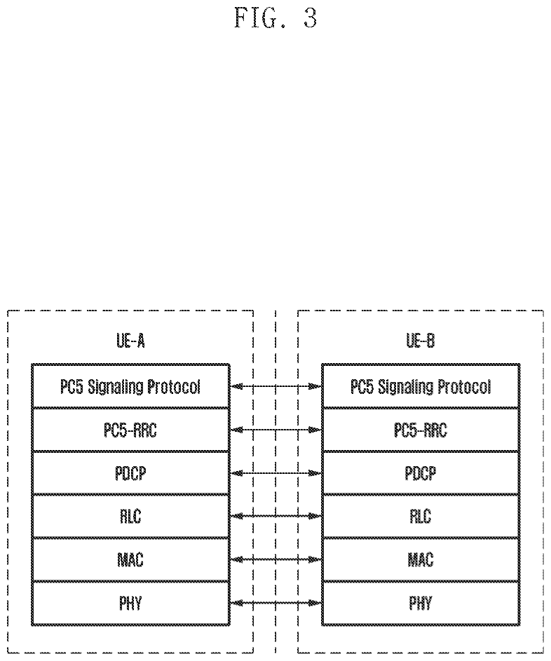

FIG. 3 illustrates a protocol of a sidelink terminal to which an embodiment of the disclosure is applied.

Although not shown in FIG. 3, application layers of UE-A and UE-B may perform a service discovery. Here, the service discovery may include a discovery for which sidelink communication method (unicast, groupcast, or broadcast) will be performed by each terminal. Accordingly, in FIG. 3, it is assumed that UE-A and UE-B recognize through a service discovery process performed in their application layers that they will perform a unicast communication scheme. The sidelink UEs may acquire information on a source identifier (ID) and a destination ID for sidelink communication in the service discovery process.

When the service discovery process is completed, a PC-5 signaling protocol layer shown in FIG. 3 may perform a D2D direct link connection setup procedure. In this case, security setup information for D2D direct communication may be exchanged.

When the D2D direct link connection setup procedure is completed, a D2D PC-5 radio resource control (RRC) setup procedure may be performed in a PC-5 RRC layer of FIG. 3. In this case, information on the capabilities of UE-A and UE-B may be exchanged, and access stratum (AS) layer parameter information for unicast communication may be exchanged.

When the PC-5 RRC setup procedure is completed, UE-A and UE-B may perform unicast communication.

Although unicast communication is described above as an example, it can be extended to groupcast communication. For example, when UE-A and UE-B, and UE-C which is not shown in FIG. 3 perform groupcast communication, UE-A and UE-B may perform the service discovery for unicast communication, the D2D direct link setup procedure, and the PC-5 RRC setup procedure as described above. In addition, UE-A and UE-C may perform the service discovery for unicast communication, the D2D direct link setup procedure, and the PC-5 RRC setup procedure. Finally, UE-B and UE-C may perform the service discovery for unicast communication, the D2D direct link setup procedure, and the PC-5 RRC setup procedure. That is, instead of performing a separate PC-5 RRC setup procedure for groupcast communication, each pair of transmission/reception UEs participating in groupcast communication may perform the PC-5 RRC setup procedure for unicast communication. However, in the groupcast method, it may not always be necessary to perform the PC5 RRC setup procedure for unicast communication. For example, there may be scenario of groupcast communication performed without PC5 RRC connection setup, and in this case, the PC5 RRC setup procedure for unicast transmission may be omitted.

The PC-5 RRC setup procedure for unicast or groupcast communication may be applied to all of in-coverage, partial coverage, and out-of-coverage scenarios shown in FIG. 1. When UEs to perform unicast or groupcast communication exist within the coverage of a base station, the UEs may perform the PC-5 RRC setup procedure before or after performing downlink or uplink synchronization with the base station.

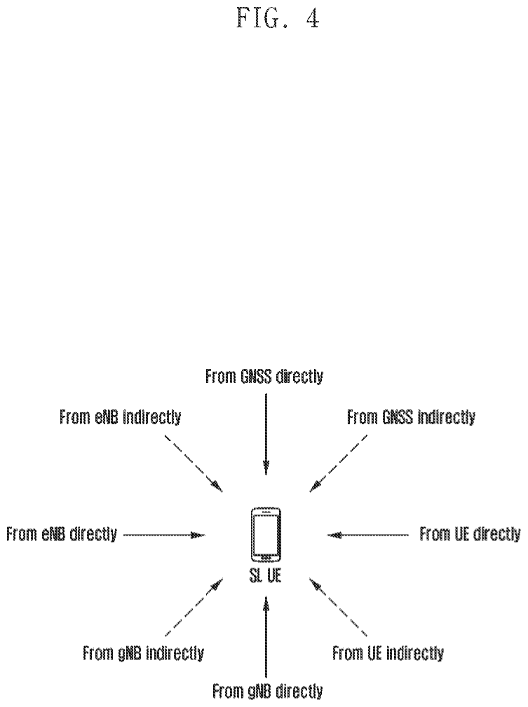

FIG. 4 illustrates types of synchronization signals that may be received by a sidelink terminal to which an embodiment of the disclosure is applied.

Specifically, the following sidelink synchronization signals may be received from various sidelink synchronization sources.
The sidelink UE may directly receive a synchronization signal from a global navigation satellite system (GNSS) or a global positioning system (GPS).
In this case, the sidelink synchronization source may be the GNSS.
The sidelink UE may indirectly receive a synchronization signal from the GNSS or the GPS.
Indirectly receiving a synchronization signal from the GNSS may refer to a case in which sidelink UE-A receives a sidelink synchronization signal (SLSS) transmitted by sidelink UE-1 that is directly synchronized with the GNSS. Here, the sidelink UE-A may receive a synchronization signal from the GNSS through two hops. In another example, sidelink UE-2 that is synchronized with a sidelink synchronization signal (SLSS) transmitted by sidelink UE-1 that is synchronized with the GNSS may transmit the SLSS. Upon receiving this, sidelink UE-A may receive a synchronization signal from the GNSS through three hops. Similarly, sidelink UE-A may receive a synchronization signal from the GNSS through more than three hops.
In this case, the sidelink synchronization source may be another sidelink UE that is synchronized with the GNSS.
The sidelink UE may directly receive a synchronization signal from an LTE base station (i.e., eNB).
The sidelink UE may directly receive a primary synchronization signal (PSS)/secondary synchronization signal (SSS) transmitted from the LTE base station.
In this case, the sidelink synchronization source may be the eNB.
The sidelink UE may indirectly receive a synchronization signal from the LTE base station (i.e., eNB).
Indirectly receiving a synchronization signal from the eNB may refer to a case in which the SLSS transmitted by sidelink UE-1 that is directly synchronized with the eNB is received by sidelink UE-A. Here, the sidelink UE-A may receive a synchronization signal from the eNB through two hops. In another example, sidelink UE-2 that is synchronized with an SLSS transmitted by sidelink UE-1 that is directly synchronized with the eNB may transmit the SLSS. Upon receiving this, sidelink UE-A may receive a synchronization signal from the eNB through three hops. Similarly, sidelink UE-A may receive a synchronization signal from the eNB through more than three hops.
In this case, the sidelink synchronization source may be another sidelink UE that is synchronized with the eNB.
The sidelink UE may directly receive a synchronization signal from an NR base station (gNB).
The sidelink UE may directly receive the primary synchronization signal (PSS)/secondary synchronization signal (SSS) transmitted from the NR base station.
In this case, the sidelink synchronization source may be a gNB.

The sidelink UE may indirectly receive a synchronization signal from an NR base station (gNB).

Indirectly receiving a synchronization signal from the gNB may refer to a case in which the SLSS transmitted by sidelink UE-1 that is directly synchronized with the gNB is received by another sidelink UE-A. In this case, the sidelink UE-A may receive a synchronization signal from the gNB through two hops. In another example, sidelink UE-2 that is synchronized with an SLSS transmitted by sidelink UE-1 that is directly synchronized with the gNB may transmit the SLSS. Upon receiving this, sidelink UE-A may receive a synchronization signal from the gNB through three hops. Similarly, sidelink UE-A may receive a synchronization signal from the gNB through more than three hops.
In this case, the sidelink synchronization source may be another sidelink UE that is synchronized with the gNB.
The sidelink UE-A may directly receive a synchronization signal from another sidelink UE-B.
When the sidelink UE-B fails to detect the SLSS transmitted from the GNSS, the gNB, the eNB, or another sidelink UE as a synchronization source, the sidelink UE-B may transmit the SLSS based on its own timing. The sidelink UE-A may directly receive the SLSS transmitted by the sidelink UE-B.
In this case, the sidelink synchronization source may be a sidelink UE.
The sidelink UE-A may indirectly receive a synchronization signal from another sidelink UE-B.
Indirectly receiving a synchronization signal from the sidelink UE-B may refer to a case in which sidelink UE-A receives an SLSS transmitted by sidelink UE-1 that is directly synchronized with the sidelink UE-B. In this case, the sidelink UE-A may receive a synchronization signal from the sidelink UE-B through two hops. In another example, sidelink UE-2 that is synchronized with an SLSS transmitted by sidelink UE-1 directly synchronized with the sidelink UE-B may transmit the SLSS. Upon receiving this, sidelink UE-A may receive a synchronization signal from the sidelink UE-B through three hops. Similarly, sidelink UE-A may receive a synchronization signal from the sidelink UE-B through more than three hops.
In this case, the sidelink synchronization source may be another sidelink UE that is synchronized with a sidelink UE.

The sidelink UE may receive a synchronization signal from the above-described various synchronization sources, and may perform synchronization based on the synchronization signal transmitted from a synchronization source having a higher priority according to preconfigured priorities.

For example, in the order from a synchronization signal having a higher priority to a synchronization signal having a lower priority, the following priorities may be preconfigured.

### Case A

1) A synchronization signal transmitted by a GNSS>2) A synchronization signal transmitted by a UE that performs synchronization directly from a GNSS>3) A synchronization signal transmitted by a UE that performs synchronization indirectly from a GNSS>4) A synchronization signal transmitted by an eNB or gNB>5) A synchronization signal transmitted by a UE that performs synchronization directly from an eNB or gNB>6) A synchronization signal transmitted by a UE that performs synchronization indirectly from an eNB or gNB>7) A synchronization signal transmitted by a UE that does not perform direct or indirect synchronization with a GNSS, eNB, or gNB.

Case A is an example of a case in which a synchronization signal transmitted by the GNSS has the highest priority. Alternatively, cases where a synchronization signal transmitted by the eNB or the gNB has the highest priority may be considered, and the following priorities may be preconfigured.

### Case B

1) A synchronization signal transmitted by an eNB or gNB>2) A synchronization signal transmitted by a UE that performs synchronization directly from an eNB or gNB>3) A synchronization signal transmitted by a UE that performs synchronization indirectly from an eNB or gNB>4) A synchronization signal transmitted by a GNSS>5) A synchronization signal transmitted by a UE that performs synchronization directly from a GNSS>6) A synchronization signal transmitted by a UE that performs synchronization indirectly from a GNSS>7) A synchronization signal transmitted by a UE that does not perform direct or indirect synchronization with a GNSS, eNB, or gNB.

Whether sidelink UE should follow the Case A priorities or the Case B priorities may be configured from a base station or may be preconfigured. More specifically, when the sidelink UE exists in the coverage of the base station (i.e., in-coverage), the base station may configure, through system information (e.g., SIB) or RRC signaling, whether the sidelink UE should follow the Case A priorities or the Case B priorities. In case that the sidelink UE exists outside the coverage of the base station (i.e., out-of-coverage), whether the sidelink UE should follow the Case A priorities or the Case B priorities may be preconfigured.

When the base station configures the Case A for the sidelink UE through system information or RRC signaling, the base station may further configure whether or not, in Case A, the sidelink UE considers priority 4 (the case of being synchronized with a synchronization signal transmitted by an eNB or gNB), priority 5 (the case of being synchronized with a synchronization signal transmitted by a UE that performs synchronization directly from eNB or gNB), and priority 6 (the case of being synchronized with a synchronization signal transmitted by a UE that performs synchronization indirectly from eNB or gNB). That is, when Case A is configured and it is further configured to consider priority 4, priority 5, and priority 6, all priorities of Case A (i.e., from priority 1 to priority 7) will be considered. On the other hand, when Case A is configured and it is not configured to consider priority 4, priority 5, and priority 6, or when Case A is configured and it is configured not to consider priority 4, priority 5, and priority 6, all of priority 4, priority 5, and priority 6 will be omitted from Case A (i.e., only priority 1, priority 2, priority 3, and priority 7 are considered).

The sidelink synchronization signal mentioned in the disclosure may refer to a sidelink synchronization signal block (S-SSB). In addition, the S-SSB may be configured by a sidelink primary synchronization signal (S-PSS), a sidelink secondary synchronization signal (S-SSS), and a physical sidelink broadcast channel (PSBCH). The S-PSS may be configured by a Zadoff-Chu sequence or an M-sequence, and the S-SSS may be configured by an M-sequence or a gold sequence. Similar to PSS/SSS in the cellular system, a sidelink ID may be transmitted through a combination of the S-PSS and the S-SSS or through only the S-SSS instead of this combination. Similar to a physical broadcast channel (PBCH) of the cellular system, the PSBCH may transmit master information block (MIB) for sidelink communication.

In the disclosure, a case where a sidelink parameter is preconfigured in a sidelink UE may be mainly applied to when the sidelink UE is located outside the coverage of a base station (out-of-coverage scenario). The meaning that the parameter is preconfigured in the UE may be interpreted as using a value embedded in the UE when the UE is released from the factory. In another example, this may indicate that the sidelink UE accesses the base station and obtains and stores the sidelink parameter information in advance through RRC configuration. In still another example, this may indicate that the sidelink UE obtains and stores the sidelink system information in advance from the base station, even though the sidelink UE does not access the base station.

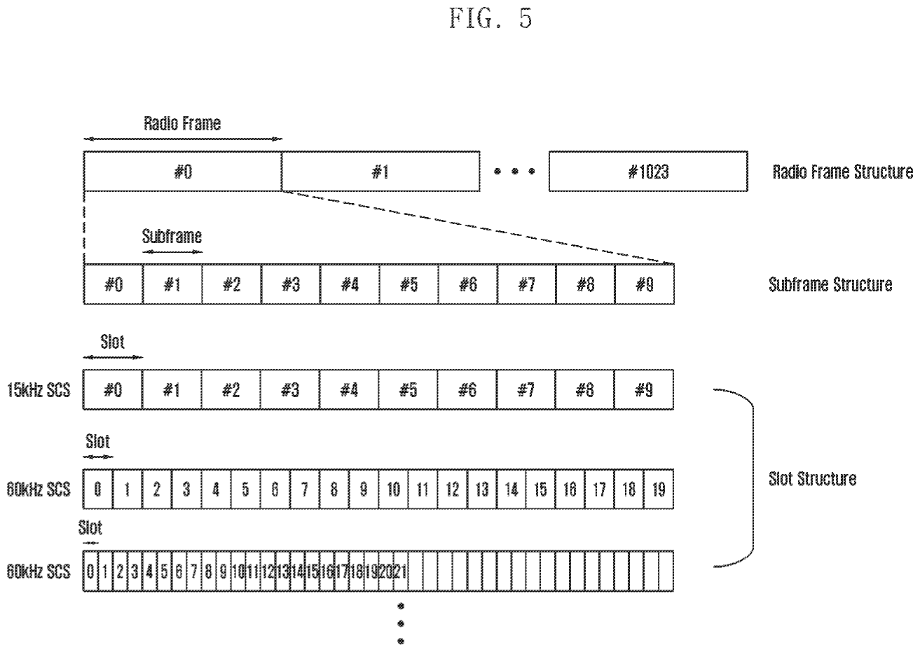

FIG. 5 illustrates a frame structure of a sidelink system according to an embodiment of the disclosure.

FIG. 5 shows that the system operates 1024 radio frames, but this is not a limitation. For example, a specific system may use fewer or more radio frames than 1024, and the amount of radio frames the system uses may be configured by a base station or may be preconfigured. More specifically, when a sidelink UE is located in the coverage of the base station, the sidelink UE may obtain information on the radio frame through an MIB of PBCH transmitted by the base station. When a sidelink UE is located outside the coverage of the base station, information on the radio frame may be preconfigured in the sidelink UE.

In FIG. 5, a radio frame number and a system frame number may be treated equally. That is, the radio frame number ‘0’ may correspond to the system frame number ‘0’, and the radio frame number ‘1’ may correspond to the system frame number ‘1’. One radio frame may consist of 10 subframes, and one subframe may have a length of 1 millisecond (ms) on the time axis. The number of slots constituting one subframe may vary as shown in FIG. 5, depending on the subcarrier spacing used in the NR V2X. For example, when a 15 kHz subcarrier spacing is used in the NR V2X communication, one subframe may be equal to one slot. However, when a 30 kHz subcarrier spacing and a 60 kHz subcarrier spacing are used in the NR V2X communication, one subframe may be equal to two slots and four slots, respectively. This may be applied to even cases in which a subcarrier spacing of 120 kHz or more is used, although not shown in FIG. 5. That is, generalizing the number of slots constituting one subframe, the number of slots constituting one subframe may increase by 2″ as the subcarrier spacing increases based on a 15 kHz subcarrier spacing, where n may have a value of 0, 1, 2, 3, . . . (n=0, 1, 2, 3, . . . ).

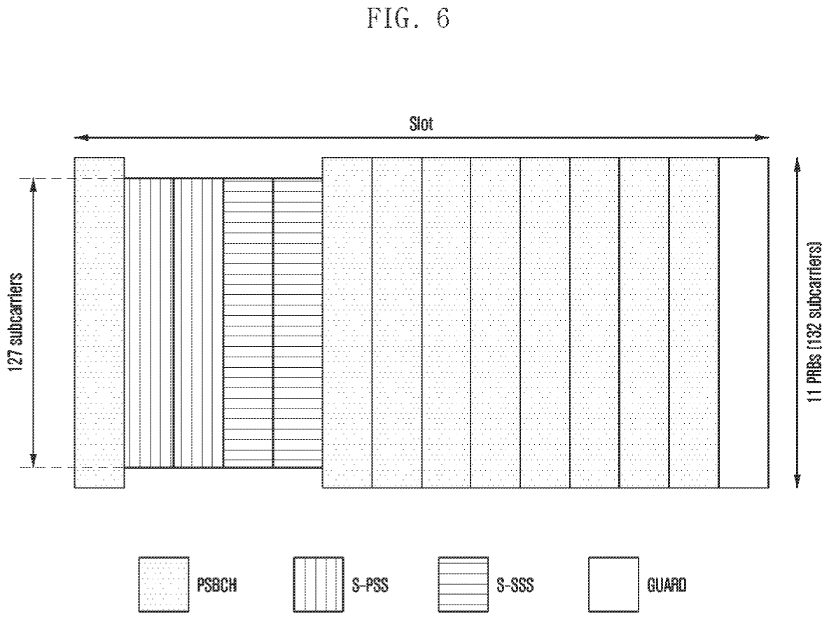

FIG. 6 illustrates a structure of a sidelink synchronization channel according to an embodiment of the disclosure.

The sidelink synchronization channel may be expressed by being replaced with a sidelink synchronization signal block (S-SSB), and one S-SSB may consist of 14 symbols as shown in FIG. 6. One S-SSB may be configured by a sidelink primary synchronization signal (S-PSS), a sidelink secondary synchronization signal (S-SSS), a physical sidelink broadcast channel (PSBCH), and a guard period (GAP). Here, each of the S-PSS and S-SSS may be configured by two OFDM symbols, the PSBCH may be configured by nine OFDM symbols, and the GAP (or GUARD) may be configured by one OFDM symbol.

As shown in FIG. 6, the S-PSS may be mapped to OFDM symbol indices 1 and 2, the S-SSS may be mapped to OFDM symbol indices 3 and 4, and the GAP may be mapped to the last OFDM symbol of the S-SSB (i.e., OFDM symbol index 13). The PSBCH may be mapped to the remaining OFDM symbols except for the S-PSS, the S-SSS, and the GAP. Although FIG. 6 shows that the S-PSS and the S-SSS are located in consecutive symbols, the S-PSS and the S-SSS may be located apart from each other with one symbol interposed therebetween. That is, the S-PSS may be mapped to OFDM symbol indices 1 and 2, the S-SSS may be mapped to OFDM symbol indices 4 and 5, and the PSBCH may be mapped to OFDM symbol indices 0, 3, 6, 7, 8, 9, 10, 11, and 12. Meanwhile, although not shown in FIG. 6, a demodulation reference signal (DMRS) may be transmitted in each OFDM symbol to which the PSBCH is mapped.

Information transmitted through the PSBCH may include at least one of the following pieces of information.
1. Frame Number: This may be information indicating a frame number at which the S-SSB (i.e., S-PSS, S-SSS, and PSBCH) is transmitted. When the sidelink UE for transmitting the S-SSB is located within the coverage of a base station, the frame number may be configured based on a system frame number of the base station in which the sidelink UE is located. When the sidelink UE for transmitting the S-SSB is located outside the coverage of a base station, the frame number may be preconfigured based on a frame number of the UE for transmitting the S-SSB. The frame number may consist of 10 bits.
2. Downlink and Uplink Configuration Information: As shown in FIG. 1B, a sidelink UE located within the coverage of a base station may perform sidelink communication with a sidelink UE located outside the coverage of the base station (i.e., partial-coverage scenario). In FIG. 1B, the base station in which UE-1 is located may be operating as a time division duplexing (TDD) system. Here, sidelink signals transmitted by UE-2 and UEs, although not shown in FIG. 1B, located outside the coverage of the base station may cause interference. More specifically, when UE-1 receives control information and data information from the base station through downlink, sidelink control information and data information transmitted by UE-2 may cause interference to downlink signals received by UE-1. In FIG. 1B, when UE-1 is located at the edge of the coverage of the base station (that is, UE-1 is far from the base station), and UE-2 is located adjacent to UE-1, the interference problem may become serious. On the other hand, when UE-1 transmits control information and data information to the base station through uplink, sidelink control information and data information transmitted by UE-2 may cause interference to uplink signals of UE-1 received by the base station. However, since UE-2 is further away from the base station than UE-1, signals received from UE-2 at a receiver of the base station may not cause much interference to signals received from UE-1. In addition, since the base station may have more reception antennas compared to a receiver of UE-1, the base station may use more advanced reception techniques such as interference cancellation. Therefore, when comparing the case where signals of UE-2 cause interference to the receiver of UE-1 and the case where signals of UE-2 cause interference to the receiver of the base station, the former case may have a greater effect on system performance.

In order to solve the above interference problem in the TDD system, the sidelink UE that transmits the S-SSB within the coverage of the base station may transmit TDD configuration information (i.e., downlink and uplink configuration information to be followed by all UEs located within the coverage of the base station), configured by the base station, to another sidelink UE located outside the coverage of the base station through the PSBCH. Upon receiving the above information through the PSBCH, the sidelink UE located outside the coverage of the base station may configure a resource pool for transmitting and receiving sidelink control information and data information by using only an uplink subframe or an uplink slot except for a downlink subframe, a special subframe, a downlink slot, and a flexible slot.
3. Slot Index: As shown in FIG. 5, one system frame may consist of a plurality of subframes. In addition, depending on a subcarrier spacing, one subframe may consist of a plurality of slots. Therefore, an indicator indicating in which slot of the indicated frame the S-SSB is transmitted may be required. The slot index may refer to information indicating the index of a slot through which the S-SSB is transmitted in a frame index indicated by the frame number. For example, the subcarrier spacing of 15 kHz, 30 kHz, 60 kHz, or 120 kHz may be configured by 10 slots, 20 slots, 40 slots, and 80 slots within one frame consisting of 10 ms. Accordingly, 7 bits may be required to transmit 80 slot indices.
4. Coverage Indicator: As described above in FIG. 4, when it is configured that the synchronization signal of the base station has a higher priority than that of the GNSS, the S-SSB transmitted by a sidelink UE that is directly synchronized from the base station may have a higher priority than the S-SSB transmitted by any other sidelink UE. That is, the S-SSB transmitted by a sidelink UE that is directly synchronized from the base station may have a higher priority than the S-SSB transmitted by a sidelink UE directly or indirectly synchronized with the GNSS and the S-SSB transmitted by a sidelink UE directly or indirectly synchronized with the S-SSB transmitted by another sidelink UE. This may indicate that timing of the base station is transmitted to a sidelink UE located outside the coverage of the base station through a sidelink UE located in the coverage of the base station. For determining the priority, a 1-bit indicator indicating a coverage state may be included in the PSBCH. For example, when the 1-bit indicator is configured as ‘1’, this may indicate that the sidelink UE which has transmitted the PSBCH is located within the coverage of the base station. In addition, when the 1-bit indicator is configured as ‘0’, this may indicate that the sidelink UE which has the PSBCH is located outside the coverage of the base station. Therefore, the sidelink UE that has received the PSBCH may determine whether the S-SSB received by the sidelink UE itself is transmitted from a sidelink UE located in the coverage of the base station or from a sidelink UE located outside the coverage of the base station. Based on this, it is possible to determine to which S-SSB the sidelink synchronization should be performed (i.e., selection of a sidelink synchronization source).

In addition to the above-mentioned information, the PSBCH may include a reserved bit that is not used in the current release. For example, a reserved bit consisting of 2-bit or 1-bit may be included, which may be used for a later release UE (i.e., a sidelink UE of Release 16 does not interpret the reserved bit, and when the reserved bit is used for the introduction of a new sidelink function in Release 17 or more, a sidelink UE of Release 17 or more may interpret the corresponding bit).

In addition, the sidelink synchronization channel may be used in a licensed band or an ITS band or an unlicensed band, which is a frequency band for vehicle communication, and sidelink synchronization channel information included in respective bands may be the same or at least partially different.

In FIG. 6, among sidelink synchronization channels, the frequency size of PSBCH is 132 subcarriers (11 PRBs), and the frequency size of the S-PSS and S-SSS is 127 subcarriers. This may be applied only to Rel-16 5G NR V2X, and it may be possible to be configured in a different value or form in subsequent Releases.

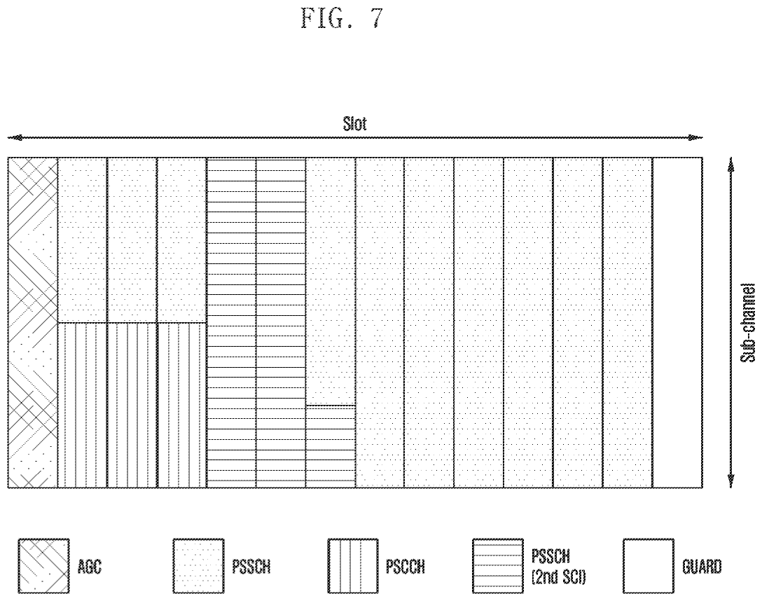

FIG. 7 illustrates the structure of a sidelink channel according to an embodiment of the disclosure.

For sidelink data transmission and reception, basically, the sidelink channel may basically consist of one adaptive gain controller (AGC) symbol for antenna gain control, three physical sidelink Control channels (PSCCH), 12 physical sidelink shared channels (PSSCH), and one GUARD symbol, as shown in FIG. 7.

In FIG. 7, the number of symbols for each physical channel is only an example, and it may be possible to configure different numbers of symbols for each channel. The PSSCH may include, as well as data information, second control information (2nd SCI) indicated by first control information (1st sidelink control information (SCI)) included in the PSCCH, and as shown in FIG. 7, may be configured only with the PSSCH without 2nd SCI information. The first symbol is an AGC symbol and is configured by the same information as that of the second symbol. The reason why the AGC symbol is needed as follows. One of the main characteristics of sidelink communication is that there may be multiple transmission nodes that desire to transmit and they may have different distances from a reception node and have different transmission powers. Accordingly, from the point of view of the reception node, a difference in received power strength may occur depending on which transmission node performs SL communication. Therefore, since the reception node needs some time to correct this difference, the first symbol is allocated as the AGC symbol for this as shown in FIG. 7. The PSCCH is a physical channel that delivers sidelink control information (SCI), and may have at least one value among 10, 12, 15, 20, and 25 PRBs in one sub-channel, which may be configured by a higher layer signal. Although the number of symbols of PSCCH is shown as 3 symbols in FIG. 7, one symbol or two symbols are possible, and this value may be configured by a higher layer signal. Mapping of control information included in the PSCCH is performed from the lowest PRB index first.

The PSSCH is a physical channel that delivers sidelink data information (e.g., a transport block (TB)), and 2nd SCI information may be mapped from a first DMRS symbol transmitted on the PSSCH. The PSSCH may be transmitted in units of one sub-channel, and the size of one sub-channel may have at least one value among 10, 12, 15, 20, 25, 50, and 100 PRBs, and 1 to a maximum of 27 sub-channels may exist within one SL BWP. In addition, when the PSSCH and the PSCCH have the same PRB, the second, third, and fourth symbols in FIG. 7 may become symbols entirely configured by PSCCHs. Although not separately indicated in FIG. 7, a demodulation reference signal (DMRS) for decoding the PSSCH may be included in the 5th symbol. In addition, although not separately indicated in FIG. 7, a physical sidelink feedback channel (PSFCH) that delivers HARQ-ACK information for the PSSCH, rather than a PSSCH, may exist in the 12th and 13th symbols. In case that the PSFCH exists, the 10th symbol may be a GUARD symbol. The purpose of introducing the GUARD symbol is that a UE that has received a PSSCH needs a separate conversion (switching) time to transmit a PSFCH, and to this end, one symbol is added. In addition, the reason why the 14th symbol is a GUARD symbol is similar to the above, and when explaining based on FIG. 7 as an example, it can be seen that a time for switching between transmission and reception is required for at least one of a case in which a UE having transmitted a PSCCH/PSSCH in slot n receives the PSCCH/PSSCH from another UE in slot (n+1), and a case in which a UE having received a PSCCH/PSSCH in slot n transmits the PSCCH/PSSCH to another UE in slot (n+1). A transmission format transmitted by the UE in the PSFCH may be the same as PUCCH format 0 defined in the 3GPP Rel-15 NR standard, and may be configured in the form in which transmission is repeatedly performed over one PRB and two symbols based on the Zadoff-Chu sequence. As described above, the first symbol of the two symbols of the PSFCH may be used for the AGC.

In the description above, the first control information provides information related to resource allocation, and may include at least one of, e.g., frequency resource information, time resource information, a DMRS pattern, a second control information format, a size of resource to which the second control information is allocated, the number of DMRS ports, an MCS, and PSFCH transmission or not. Among the above examples, the DMRS pattern is a field notifying of information of time and frequency resources to which the DMRS for PSSCH reception is allocated, the second control information format is a field notifying of configuration information and the size of the second control information transmitted to the PSSCH, the size of resource to which the second control information is allocated is a field notifying the PSSCH of the amount of resources to which the second control information is allocated, the number of DMRS ports is a field notifying of information indicating the number of ports through which the DMRS is transmitted, and the MCS is an abbreviation for a modulation and coding scheme and is a field notifying of PSSCH encoding information. The second control information provides UE-specific or specific information related to the corresponding service, and may include at least one of, e.g., a HARQ process number, a new data indicator (NDI), a redundancy version (RV), a source ID, a destination ID, a HARQ feedback enabled/disabled indicator, a cast type indicator, and a CSI request field. In the example above, the NDI is a field configured by 1 bit and indicating whether a currently transmitted TB of a PSSCH is a retransmission or initial transmission. In this field, when toggling (changed from 1 to 0, or from 0 to 1) occurs, it is determined as an initial (or new) transmission, and when toggling does not occur, it is determined as retransmission. The RV is a field indicating a start point of an encoded bit when PSSCH is encoded based on low density parity check (LDPC) coding. The source ID is the ID of a UE having transmitted the PSSCH and the destination ID is the ID of a UE receiving the PSSCH. The HARQ feedback enabled/disabled indicator is an indicator field indicating whether or not HARQ feedback transmission occurs with respect to the corresponding PSSCH transmission. The cast type indicator is a field indicating whether the currently transmitted PSSCH is unicast, group cast, or broadcast. The CSI request field is a field including an instruction for the reception UE to send measured CSI information to the transmission UE. A time resource for sidelink communication may be configured to have one value among 7 to 14 symbols within one slot consisting of 14 symbols for each SL bandwidth part (BWP).

The structure for transmitting and receiving the synchronization channel and the control/data channel for sidelink communication has been described with reference to FIGS. 6 and 7. This structure for transmitting and receiving the synchronization channel and the control/data channel for sidelink communication described in FIGS. 6 and 7 may also be applied to unlicensed bands, but there may be a problem of compliance with specific conditions due to different regulations and restrictions in each country or continent. One of the specific conditions is an occupied channel bandwidth (OCB), the definition of which is that a frequency bandwidth containing 99% of transmission signal power should be included in 80% to 100% of the nominal channel bandwidth in which the transmission signal is performed. For example, in an unlicensed bandwidth having the size of a channel frequency bandwidth of 20 MHz, it may be seen that the UE satisfies the above regulation only when it unconditionally performs transmission of at least 16 MHz. For reference, the value of 80% is just an example and may be a different value for each country. However, in the case of a UE, the use of a wide bandwidth may cause lowering the transmission power efficiency to reduce the transmission distance, which results in reducing the communication radius in the unlicensed bandwidth. Therefore, when at least one PRB per specific M PRBs is allocated in terms of frequency without necessarily being allocated consecutively in a bandwidth to which a signal including 80% to 100% of the channel frequency bandwidth is allocated, it is possible to satisfy the above regulation. A method of allocating control or data information at regular intervals in terms of frequency, rather than a method of allocating the control or data information consecutively, is referred to as an interlace method of resource allocation. For example, an interlace block ‘m’ may have a value of 0 to (M−1), the value of ‘m’ may be considered that a resource is actually allocated to a common resource block {m, M+m, 2M+m, 3M+m, . . . }, and the value of ‘M’ may have a different value depending on a subcarrier spacing. The interlace method does not need to be satisfied in all countries and continents that use unlicensed bands, may be used only in countries and continents that should satisfy some relevant regulations, and the configuration may be made by a higher layer signal. However, in the case of side link communication, since it is necessary to support communication in an area outside the coverage without a separate configuration of the base station, it is possible to support sidelink communication in an area requiring the relevant regulation, by considering GPS information, pre-determined location information, or the interlace structure at the time of manufacturing the UE. Considering whether the OCB regulation is satisfied based on the sidelink channel structure described in FIG. 6 or FIG. 7, first, in the case of a synchronous channel configured by 11 PRBs in FIG. 6, transmission of the synchronous channel is difficult in a system having a channel frequency bandwidth configured by 100 PRBs because the above OCB regulation is not satisfied. Further, in the case of PSCCH and/or PSSCH configured by 20 PRBs, for example, in FIG. 7, transmission of a control channel and/or a data channel is difficult in a system having a channel frequency bandwidth configured by 100 PRBs because the above OCB regulation is not satisfied. Since the 100 PRBs correspond to the number of possible PRBs in a 20 MHz band having a subcarrier spacing of 15 kHz, it is difficult to freely utilize the structures of FIGS. 6 and 7 to perform sidelink communication in such an environment. Since it is possible to configure PSCCH/PSSCH configured by 100 PRBs in FIG. 7, the transmission of control/data channel is possible while satisfying the OCB requirements in a limited manner. However, since FDM with other UEs is not allowed, only one UE may perform data transmission/reception at a specific moment.

Hereinafter, a structure of a sidelink channel considering OCB requirements and interlaces will be described.

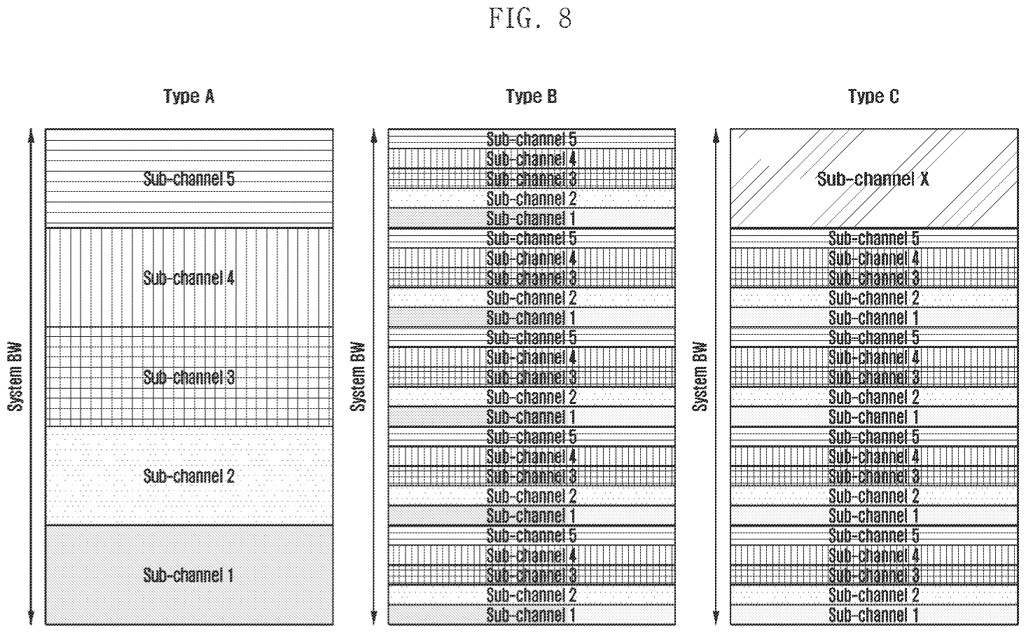

FIG. 8 illustrates a sub-channel structure for sidelink communication according to an embodiment of the disclosure.

The PSCCH/PSSCH described in FIG. 7 may be transmitted and received within one sub-channel, and a system bandwidth may include a plurality of sub-channels. FIG. 8 illustrates the presence of five sub-channels in a single system frequency bandwidth. When a terminal uses only one sub-channel to transmit and receive control and data information, such as Type A in FIG. 8, only 20% of the channel bandwidth is used in terms of a system bandwidth and thus it is difficult to satisfy the requirement of at least 80% of the bandwidth. For reference, even in case that five terminals use each sub-channel to use a total of 100% of the system channel bandwidth from the perspective of the system, this case cannot be considered to satisfy the OCB regulation because the OCB regulation refers to a channel bandwidth occupied by a single terminal in an unlicensed band. Therefore, a structure such as Type B or Type C in FIG. 8 may be considered in order to satisfy the OCB regulation.

Type B shows a structure in which each sub-channel of the Type A structure is divided by one-fifth into five sub-channels mapped according to an interlace format in the frequency domain. For example, when one sub-channel has a size of 20 PRBs in the Type A structure, a total of five sub-channels each having a size of 4 PRBs may be allocated to each interlace interval of 20 PRBs in the Type B structure. The sub-channel size Y PRBs and the number of interlaces X may have a relationship of an integer multiple. When a relationship other than that of integer multiple is possible, different PRBs may be allocated to each sub-channel by rounding up or rounding down. For example, in case that the number of system PRBs is 80 PRBs and the number of sub-channels is 7, since a value obtained by dividing 80 by 7 is 11.429 which is a decimal value (80/7=11.429), it may be difficult to allocate the same PRBs to each sub-channel. Therefore, in this case, some sub-channels may have a size of 12 PRBs (i.e., ceil (80/7)=12 PRBs) and the remaining sub-channels may have a size of 11 PRBs floor (i.e., (80/7)=11 PRBs). As a method of determining a sub-channel and the number of sub-channels that are allocated 12 PRBs and 11 PRBs for each sub-channel, a method of allocating 12 PRBs to the first or last 3 sub-channels, since 80−7*floor(80/7)=3, and thereafter, allocating 11 PRBs to 4 sub-channels (i.e., (7−3)=4) may be possible. These rules may be defined in advance, and the transmission and reception nodes may perform transmission and reception based on the number of PRBs allocated per sub-channel. In case of receiving a channel based on Type B by the terminal, basically, it is possible to receive the entire system frequency bandwidth, interleave resource blocks with an interlace structure, and then group the interleaved resource blocks for each sub-channel to demodulate/decode the resource block groups. In case of PSCCH, since transmission and reception are performed for each sub-channel, the reception node may know in advance exactly which resource area is used for transmission and reception of the PSCCH even if the PSCCH is transmitted according to an interlace structure, there is no increased complexity on the perspective of the reception node. For reference, control information scheduled by the PSCCH may include information about the PSSCH and information indicating how many sub-channels are used for transmission of data information. Accordingly, the reception node may be able to decode a TB, which has been transmitted through a plurality of sub-channels, based on this information. In a case of an interlace interval of Type B, five sub-channels are illustrated in FIG. 8, but this may be replaced by a number of PRBs or a number of Sub-PRBs and structured accordingly. In addition, a condition may be added that at least M sub-channels, PRBs, or Sub-PRBs should exist according to an interlace interval.

Type C is similar to Type B, with the main difference being the presence of a sub-channel X consisting only of PSCCH. Specifically, Type C shows a format in which, instead of PSCCH and PSSCH being transmitted and received in the same sub-channel in the form of TDM and FDM as in type A or type B, a frequency band in which the PSCCH is transmitted and received and a frequency band in which the PSSCH is transmitted and received are FDMed. Therefore, it is possible to transmit and receive the PSCCH in the frequency bandwidth described as sub-channel X, and to transmit and receive the PSSCH according to an interlace structure in the other frequency bands. Accordingly, since the PSCCH and PSSCH are simultaneously transmitted from the perspective of the transmission node, it is possible to fully satisfy the OCB regulations. The sub-channel X through which the PSCCH is transmitted may be determined in advance based on the number of specific PRBs and the number of symbols (or number of symbol groups) within a slot and sub-channel (or a frequency bandwidth) through which the PSCCH may be transmitted and received. Alternatively, based on an index of a specific PRB (or a specific PRB group configured by multiple PRBs) selected within sub-channel X, it is possible to determine in which sub-channel the PSSCH is transmitted among sub-channels 1 to 5 of FIG. 8. For example, when sub-channel X is configured by five PRBs, it is possible to determine PSSCH resources, which are transmitted and received through sub-channel 1, by a PSCCH transmitted and received through the first PRB. Type C structure has an advantage such that, from the perspective of the reception node, in the case of Type B, PSCCHs transmitted according to an interlace structure are required to be interleaved to decode the PSCCHs, while in the case of Type C, at least the PSCCH is received within one limited area without an interlace structure, and thus when there is no data scheduled for the reception node itself after decoding the PSCCH, the reception node may not need to perform additional processing of the schedule PSSCH in the other bandwidths, and may discard the PSCCH in a buffer. In other words, it is possible to omit the interleaving process. The interleaving may refer to rearranging resource blocks in a frequency bandwidth, for example, may refer to a process of configuring Type B to be like Type A or vice versa. Configuring the sub-channel X may be possible by a separate higher layer signal. A resource through which each PSCCH is transmitted and received within sub-channel X may be configured by one PRB to a plurality of PRBs, and may be configured by at least one value among 1 symbol to 14 symbols. In addition, sub-channel i belonging to a specific interlace where the PSSCH is transmitted and received may be determined according to the resources of the PSCCH transmitted by the transmission node in sub-channel X. Alternatively, the sub-channel i is a start sub-channel through which the PSSCH is transmitted, and transmission of the PSSCH in a plurality of sub-channels may be possible through a separate indicator.

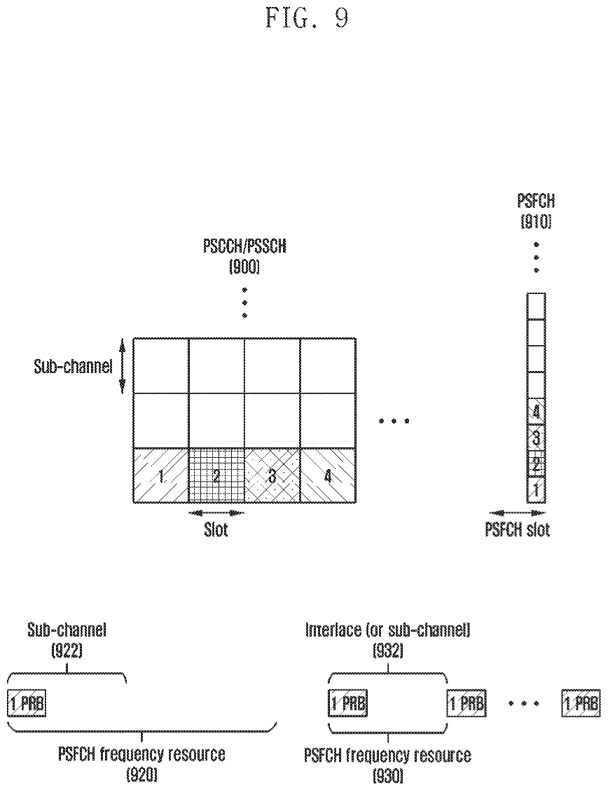

FIG. 9 illustrates a feedback channel structure for sidelink communication according to an embodiment of the disclosure.

In FIG. 9, in a sidelink, a transmission node may receive a PSFCH 910 with respect to a PSCCH/PSSCH 900 transmitted to a reception node. By receiving the PSFCH from the reception node, the transmission node may determine whether reception of the transmitted TB is successful or not, and in case that the reception is determined to be successful, no further retransmission of the TB is performed. In case that the reception is determined to be unsuccessful, retransmission of the TB may be possible. Since a plurality of transmission nodes and reception nodes in a sidelink perform transmission and reception to each other through a common sidelink channel band, when a resource area for the PSFCH is dynamically instructed, the same PSFCH resource may be instructed for the PSCCH/PSSCH transmitted by each of the plurality of transmission nodes, and accordingly, when different reception nodes use the same PSFCH resource, each transmission node may not be able to properly detect a signal received via the PSFCH. Therefore, determining the PSFCH resource in advance based on a resource area in which the PSCCH and PSSCH are transmitted and received may be reasonable. FIG. 9 shows an example of this sidelink communication. Resource z of a PSFCH for a PSCCH/PSSCH transmitted/received in a particular slot x and sub-channel y may be determined by z=f(x,y). For the efficiency of PSFCH transmission, unlike the PSCCH/PSSCH, the PSFCH is not always transmitted and received in every slot, but one PSFCH may be transmitted and received every two slots or every four slots. Transmission of each PSFCH may occur every slot, but in this case, the PSCCH/PSSCH is transmitted and received only in some symbols in one slot due to the PSFCH, which results in possibility of reducing the sidelink transmission capacity. Therefore, in order to determine the transmission resources of the PSFCH, it is possible to determine a PRB on which the PSFCH will be transmitted and received according to a slot index for each sub-channel index, as shown in FIG. 9, and thereafter the same method is performed for the next sub-channel index. Specifically, for example, HARQ feedbacks for PSCCH/PSSCH transmitted and received in slots 1, 2, 3, and 4 of sub-channel 1 may be configured to be transmitted and received in PSFCH PRB 1, 2, 3, and 4, respectively, and thereafter, HARQ feedbacks for PSCCH/PSSCH transmitted and received in slots 1, 2, 3, and 4 of sub-channel 2 may be configured to be transmitted and received in PSFCH PRBs 5, 6, 7, and 8, respectively. Alternatively, unlike FIG. 9, it is possible to determine a PRB for a PSFCH with respect to PSCCH/PSSCH transmitted and received in ascending order of the sub-channel index for each slot index and to perform the same method for the next slot index. Specifically, for example, HARQ feedbacks for PSCCH/PSSCH transmitted and received in sub-channel indices 1, 2, 3, 4, and 5 of slot 1 may be configured to be transmitted and received in PSFCH PRBs 1, 2, 3, 4, and 5, respectively, and thereafter HARQ feedbacks for the PSCCH/PSSCH transmitted and received in sub-channel indices 1, 2, 3, 4, and 5 of slot 2 may be configured to be transmitted and received in PSFCH PRBs 6, 7, 8, 9, and 10, respectively. In addition, as factors for determining PSFCH resources, at least one of the ID of the transmission node, the ID of the reception node, the number of PSFCH cyclic shifts, and the total number of PSFCH PRBs may be additionally considered, as well as the slot number and sub-channel number at which the PSCCH/PSSCH is transmitted and received. When only one PRB is transmitted for a specific PSFCH frequency resource, as indicated by reference numeral 920 in FIG. 9, PRBs more than one PRB should be transmitted in order to satisfy OCB requirements in the unlicensed band, as indicated by reference numeral 930. Therefore, in this case, a frequency resource to which a PSFCH may be mapped is limited to one interlace region, and a PSFCH that is actually transmittable by the reception node may be transmitted in a situation where one or multiple PRBs for each interlace are uniformly mapped for each interlace section. In this case, when the reception node uses the same cyclic shift value for a PSFCH mapped to each PRB in a situation of transmitting the PSFCH by one PRB for each interlace, there is a possibility that a peak to average power ratio (PAPR) value increases, which may cause a degradation of the reception performance of the reception node, and therefore it is desirable to perform transmission by using different cyclic shift values for each PRB. For example, it is possible for PRB 1 of the first interlace to use the first cyclic shift value, and PRB 2 of the second interlace to use the second cyclic shift value.

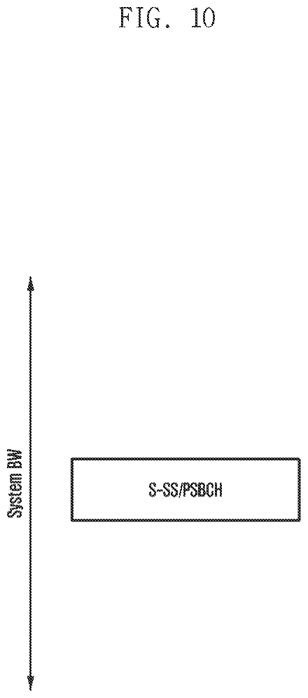

FIG. 10 illustrates a structure in which synchronization signals are transmitted and received according to an embodiment of the disclosure.

The S-SS/PSBCH structure may have the same structure as described with reference to FIG. 6. A UE transmitting the S-SS/PSBCH may be capable of transmitting an S-SS/PSBCH configured by 11 PRBs in a system frequency bandwidth. A slot in which the S-SS/PSBCH is transmitted and received may be preconfigured, and the UE may be able to perform transmission in the preconfigured slot when the conditions for transmitting the S-SS/PSBCH are satisfied. Such conditions may include whether the UE has received a synchronization signal from a GNSS or a base station. When the system frequency bandwidth for sidelink communication is much larger than the frequency bandwidth of 11 PRB in which the S-SS/PSBCH is transmitted and received, satisfying the OCB requirements in an unlicensed band may be difficult. For example, in the case of the system frequency bandwidth having 20 MHz and the subcarrier spacing of 15 kHz, there are approximately 100 PRBs within the system frequency bandwidth, and since when an S-SS/PSBCH configured by 11 PRBs is transmitted and received, only about 11% of the channel is occupied, so that satisfying the OCB conditions requiring at least 70% to 80% of the channel occupancy may be difficult. Therefore, the following description will be made for a method of transmitting and receiving the S-SS/PSBCH while satisfying OCB requirements.

### Method 10-1: Method of Transmitting After Being FDMed With PSCCH/PSSCH

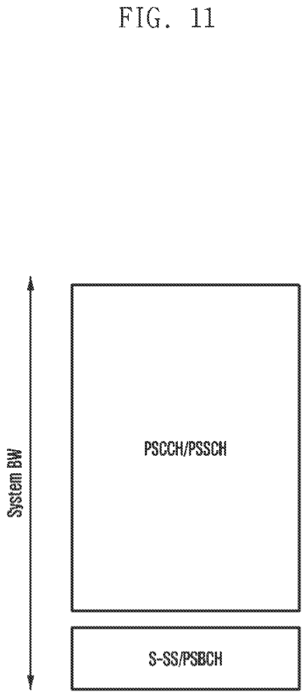

This method refers to a method in which, during transmission of S-SS/PSBCH, PSCCH/PSSCH is transmitted in other frequency bandwidths, and a transmission node may have an opportunity of additionally transmitting the PSCCH/PSSCH while satisfying the OCB requirements. However, a UE does not transmit S-SS/PSBCH when there is no PSCCH/PSSCH for transmission to another receiving UE. In other words, a transmitting UE may only transmit S-SS/PSBCH when there is a PSCCH/PSSCH. FIG. 11 shows an example of this method. Although only one PSCCH/PSSCH is shown in FIG. 11, multiple PSCCH/PSSCHs may be possible, and although FIG. 11 shows the PSCCH/PSSCHs as being assigned consecutively in the system frequency band, the PSCCH/PSSCHs may be assigned according to an interlace structure as described with reference to FIG. 8. In addition, the frequency bandwidth in which the S-SS/PSBCH is configured may be preconfigured by a higher layer signal or during manufacturing a terminal, or the S-SS/PSBCH resource may be determined based on an area in which the PSCCH/PSSCH is scheduled in a situation where a plurality of S-SS/PSBCH candidate transmission resources has been configured. The location of the resource area in which S-SS/PSBCH is transmitted and received may be determined based on the lowest PRB index of the system frequency band, or may be based on the smallest PRB index of a common frequency bandwidth. Alternatively, the location of the resource area in which S-SS/PSBCH is transmitted and received may be determined based on a resource area in which the PSCCH/PSSCH is scheduled. The synchronization signal and the control/data signal for communication (Uu) between a base station and a UE may be TDMed or FDMed with each other, or may be combined into the form of TDM and FDM, which may be determined by a subcarrier spacing, or an operating frequency bandwidth or a higher layer signal configuration for the Uu communication. On the other hand, the synchronization signal and the control/data signal for D2D sidelink communication may allow a combination only in the form of FDM as shown in FIG. 11, which may be limited to an unlicensed band, or may be limited to a region or continent where the OCB requirements should be satisfied in the unlicensed band. In the case of UE transmission power allocation, the transmitting UE may be able to allocate transmission power for S-SS/PSBCH first, and then allocate the remaining transmission power to PSCCH/PSSCH. Alternatively, it is possible to uniformly allocate transmission power to the S-SS/PSBCH and PSCCH/PSSCH according to the amount of frequency resources allocated thereto respectively. Alternatively, it is possible to apply the respectively allocated amount of frequency resources and a value of scaling to the SS/PSBCH and PSCCH/PSSCH. For example, the scaling may signify that although the SS/PSBCH and PSCCH/PSSCH each are allocated 1 PRB, the SS/PSBCH is allocated more weighted transmission power. In addition, depending on the size of a transmission resource of the S-SS/PSBCH and the system BW, it is possible to limit the number of transmission resources for which the PSCCH/PSSCH can be scheduled, and in this case, by reflecting this limitation of the number of transmission resources, the scheduling information may include information, which is different from information not including S-SS/PSBCH. In Method 10-1, although a sidelink physical channel that may be FDMed with S-SS/PSBCH and transmitted has been described as PSCCH/PSSCH, only PSCCH, only PSSCH, or the other PSFCH may exist in the sidelink physical channel. Alternatively, it is possible that a slot in which S-SS/PSBCH is transmitted does not allow PSFCH to be transmitted. This comes from the fact that when PSFCH exists, the PSFCH may need to be transmitted together with PSCCH/PSSCH, and in this case, a GAP symbol is needed within a slot due to switching time, whereas the transmission structure for S-SS/PSBCH does not include a GAP symbol, and thus, from the perspective of a slot, there may be a symbol in which only S-SS/PSBCH is transmitted within a specific symbol. Therefore, in the slot structure where PSCCH/PSSCH is transmitted and received, when a slot containing PSFCH and a slot containing S-SS/PSBCH overlap, the UE may neither transmit the PSFCH nor S-SS/PSBCH.

### Method 10-2: Transmitting Multiple S-SS/PSBCHs Within One Slot

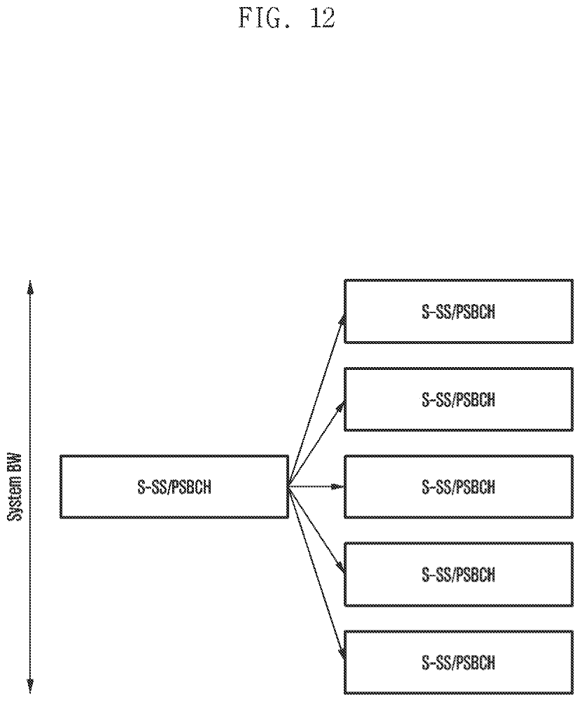

This method refers to a method of transmitting multiple S-SS/PSBCHs within a single slot to satisfy the OCB requirements, and pieces of information of the MIBs contained in the PSBCHs may be the same, or information related to the frequency bandwidth or location may be changed by considering the frequency location of the S-SS/PSBCH containing the corresponding MIB information. FIG. 12 illustrates an example of this method, wherein the number of each S-SS/PSBCH and the offset between neighboring S-SS/PSBCHs may be determined by the size of the entire system bandwidth over which the sidelink synchronization signal is transmitted and received. For example, the offset between neighboring S-SS/PSBCHs may be determined to be about 5 PRB or 6 PRB, which is half the frequency size of 11 PRB over which the S-SS/PSBCH is transmitted, or may be determined by the system frequency bandwidth width “X” PRB and the number of S-SS/PSBCHs. In the case of transmission power, a UE may perform transmission by allocating an equal amount of transmission power to each S-SS/PSBCH. Alternatively, it is possible to allocate more transmission power to one particular S-SS/PSBCH. In this case, other S-SS/PSBCHs may be allocated transmission power satisfying the minimum requirements, and the remaining transmission power resources may be allocated to one S-SS/PSBCH. A receiving UE may be able to receive a single S-SS/PSBCH even if multiple S-SS/PSBCHs are transmitted, or may be able to combine and receive S-SS/PSBCHs transmitted through different frequency channels respectively. This reception of the receiving UE may be possible under the condition that pieces of information of MIBs contained in the PSBCH are the same.
Method 10-3: Divide one S-SS/PSBCH according to each PRB or RE (subcarrier) and map the divided S-SS/PSBCH in the system frequency band.

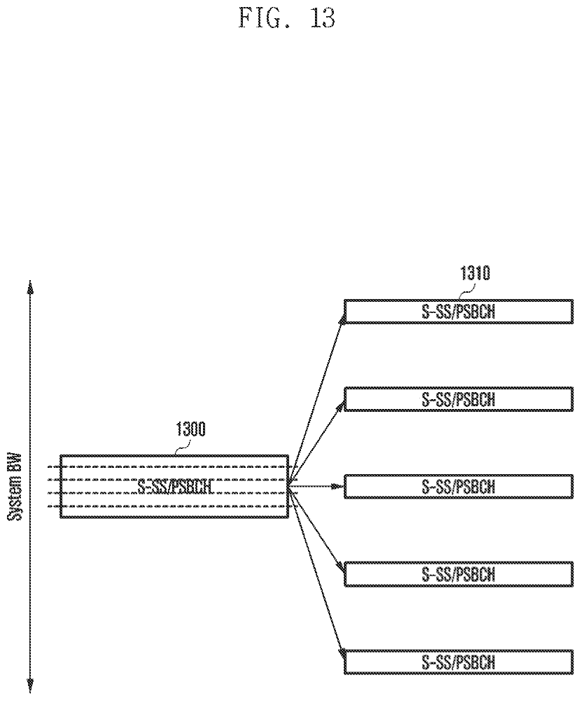

This method refers to a method of dividing S-SS/PSBCHs, each of which is configured by 11 PRBs, according to X PRBs or X REs and uniformly mapping the divided S-SS/PSBCHs in the system frequency band. For example, in case that the S-SS/PSBCHs is divided by one PRB and mapped in a system frequency band configured by 101 PRB, the divided S-SS/PSBCHs may be mapped in such a way of {PRB index 0, PRB index 10, PRB index 20, . . . , PRB index 100}. FIG. 13 illustrates an example of this method. In case that each S-SS/PSBCH is divided into five channels, the S-SS/PSBCH may be mapped after being divided by 2.2 PRBs (i.e., 11/5=2.2 PRBs), or may be mapped after being divided in the form of {3 PRB, 2 PRB, 2 PRB, 2 PRB, 2 PRB}. Alternatively, since the PSBCH has a frequency size of 11 PRBs or 132 subcarriers, the PSBCHs may be divided such that the frequency size after the division becomes uniform. For example, the PSBCHs may be divided by one of the following numbers: 1, 2, 3, 4, 6, 11, 12, 22, 33, 44, 66, and 132, which are divisors of 132. In addition, although S-PSS/S-SSS actually has 127 subcarriers, it is possible to divide the S-PSS/S-SSS to match the location of a subcarrier being transmitted, such as the PSBCH. In the case of calculating transmission power, when the S-SS/PSBCH is divided according to each PRB or subcarrier (indicated by reference numeral 1310) as shown in FIG. 13, the S-SS/PSBCH may have the same transmission power as that of the S-SS/PSBCH before division (indicated by reference numeral 1300). Alternatively, when the S-SS/PSBCH is to be divided according to each PRB or subcarrier (indicated by reference numeral 1310) as shown in FIG. 13, it is possible to determine transmission power assuming that the transmission power has been allocated by a frequency difference between the minimum and maximum values of the total transmission frequency band of the S-SS/PSBCH which has been mapped after the division.

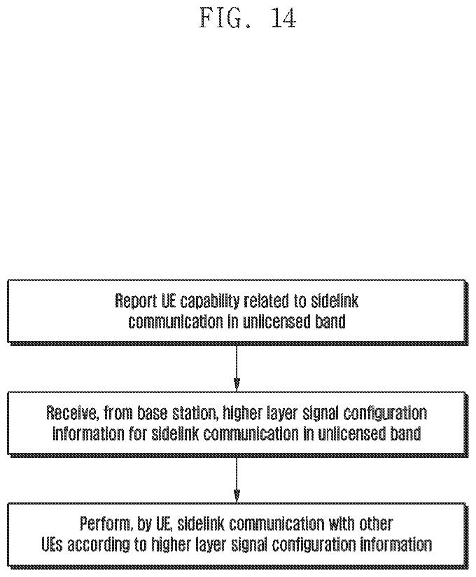

FIG. 14 illustrates an operation process for sidelink communication of a UE in an unlicensed band according to an embodiment of the disclosure.

The UE may report, to a base station, a UE capability of reporting whether sidelink communication in an unlicensed band can be performed. Alternatively, when a UE is produced without a separate report of a base station, a function related to performing sidelink communication in an unlicensed band may be mounted in advance. Thereafter, the terminal may receive, from the base station, higher layer signal configuration information for sidelink communication in an unlicensed band in which the UE itself is able to operate. The corresponding higher layer signal may include all types of signals, such as MIB, SIB, RRC, MAC CE, and PDCP, that can be delivered through the higher layer signal. When there is no connection with the base station, the UE may use sidelink-related information configured as default. Thereafter, depending on whether the OCB requirements should be satisfied in an unlicensed band based on the higher layer signal information, the UE performs sidelink communication with other UEs based on at least one or a combination of two or more of the methods and drawings described in the disclosure.

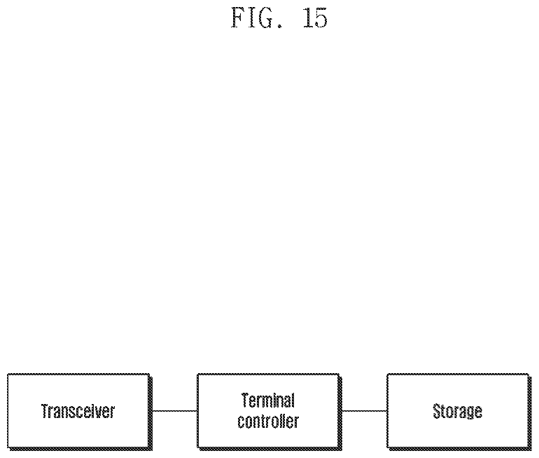

FIG. 15 illustrates a structure of a terminal according to an embodiment of the disclosure.

Referring to FIG. 15, the terminal may include a transceiver, a terminal controller, and a storage. In the disclosure, the terminal controller may be defined as a circuit, an application-specific integrated circuit, or at least one processor.

The transceiver may transmit and receive signals to and from other network entities. For example, the transceiver may receive system information from a base station, and may receive a synchronization signal or a reference signal.

The terminal controller may control the overall operation of the terminal according to an embodiment proposed by the disclosure. For example, the terminal controller may control a signal flow between respective blocks to perform operations according to the drawings and flowcharts described above. Specifically, the terminal controller operates according to a control signal received from the base station and may exchange messages or signals with other terminals and/or base stations.

The storage may store at least one of information transmitted and received through the transceiver and information generated through the terminal controller.

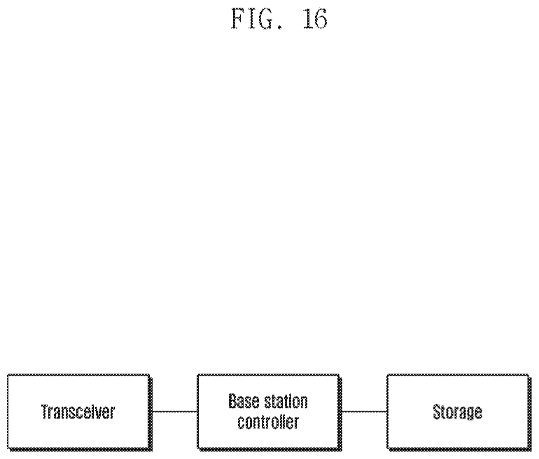

FIG. 16 illustrates a structure of a base station according to an embodiment of the disclosure.

Referring to FIG. 16, the base station may include a transceiver, a base station controller, and a storage. In the disclosure, the base station controller may be defined as a circuit, an application-specific integrated circuit, or at least one processor.

The transceiver may transmit and receive signals to and from other network entities. For example, the transceiver may transmit system information to a terminal and may transmit a synchronization signal or a reference signal.

The base station controller may control the overall operation of the base station according to an embodiment proposed in the disclosure. For example, the base station controller may control operations described in the disclosure in order to manage and reduce interference with an adjacent base station. Specifically, the base station controller transmits a control signal to the terminal so as to control the operations of the terminal and may exchange messages or signals with the terminal.

The storage may store at least one of information transmitted and received through the transceiver and information generated through the base station controller.

The embodiments of the disclosure described and shown in the specification and the drawings are merely specific examples that have been presented to easily explain the technical contents of the disclosure and help understanding of the disclosure, and are not intended to limit the scope of the disclosure. Therefore, the scope of the disclosure should be construed to include, in addition to the embodiments disclosed herein, all changes and modifications derived on the basis of the technical idea of the disclosure.

Furthermore, all or a part of a particular embodiment may be implemented in combination with all or a part of another embodiment, and implementation of concatenations or combinations of two or more embodiments also fall within the scope of the disclosure.

What is claimed is:

1. A method by a first terminal in a communication system, the method comprising:
transmitting a physical sidelink control channel (PSCCH) for allocating resources of a physical sidelink shared channel (PSSCH); and
transmitting, based on the PSCCH, the PSSCH in a first sub-channel,
wherein the first sub-channel is defined based on a plurality of interlace blocks allocated at regular intervals in a frequency domain.

2. The method of claim 1, wherein the PSCCH is transmitted in the first sub-channel through which the PSSCH is transmitted.

3. The method of claim 1, wherein the PSCCH is transmitted in a second sub-channel different from the first sub-channel through which the PSSCH is transmitted.

4. The method of claim 1, further comprising:
receiving, in a third sub-channel, a physical sidelink feedback channel (PSFCH) including hybrid automatic repeat request (HARQ) feedback for the PSSCH,
wherein the third sub-channel is same as the first sub-channel through which the PSSCH is transmitted or a second sub-channel through which the PSCCH is transmitted, and
wherein the third sub-channel is defined based on the plurality of interlace blocks allocated at regular intervals in the frequency domain, and the PSFCH is received for each of the plurality of interlace blocks of the third sub-channel.

5. The method of claim 4, wherein the PSFCH received for each of the plurality of interlace blocks of the third sub-channel is received based on different cyclic shift values.

6. The method of claim 1, further comprising:
transmitting at least one sidelink synchronization signal block (S-SSB),
wherein a plurality of S-SSBs are transmitted in one slot, or one S-SSB is transmitted after being divided in the frequency domain.

7. A method by a second terminal in a communication system, the method comprising:
receiving a physical sidelink control channel (PSCCH) for allocating resources of a physical sidelink shared channel (PSSCH); and
receiving, based on the PSCCH, the PSSCH in a first sub-channel,
wherein the first sub-channel is defined based on a plurality of interlace blocks allocated at regular intervals in a frequency domain.

8. The method of claim 7, wherein the PSCCH is received in the first sub-channel through which the PSSCH is transmitted.

9. The method of claim 7, wherein the PSCCH is received in a second sub-channel different from the first sub-channel through which the PSSCH is transmitted.

10. The method of claim 7, further comprising:
transmitting, in a third sub-channel, a physical sidelink feedback channel (PSFCH) including hybrid automatic repeat request (HARQ) feedback for the PSSCH,
wherein the third sub-channel is same as the first sub-channel through which the PSSCH is transmitted or a second sub-channel through which the PSCCH is transmitted, and
wherein the third sub-channel is defined based on the plurality of interlace blocks allocated at regular intervals in the frequency domain, and the PSFCH is transmitted for each of the plurality of interlace blocks of the third sub-channel.

11. The method of claim 10, wherein the PSFCH received for each of the plurality of interlace blocks of the third sub-channel is transmitted based on different cyclic shift values.

12. The method of claim 7, further comprising:
receiving at least one sidelink synchronization signal block (S-SSB),
wherein a plurality of S-SSBs are transmitted in one slot, or one S-SSB is received after being divided in the frequency domain.

13. A first terminal in a communication system, the first terminal comprising:
a transceiver; and
a controller configured to transmit a physical sidelink control channel (PSCCH) for allocating resources of a physical sidelink shared channel (PSSCH), and to transmit, based on the PSCCH, the PSSCH in a first sub-channel,
wherein the first sub-channel is defined based on a plurality of interlace blocks allocated at regular intervals in a frequency domain.

14. A second terminal in a communication system, the second terminal comprising:
a transceiver; and
a controller configured to receive a physical sidelink control channel (PSCCH) for allocating resources of a physical sidelink shared channel (PSSCH), and to receive, based on the PSCCH, the PSSCH in a first sub-channel,
wherein the first sub-channel is defined based on a plurality of interlace blocks allocated at regular intervals in the frequency domain.
